(19) United States
(12) Patent Application Publication
(10) Pub. No.: US 2010/0290163 A1
(43) Pub. Date: Nov. 18, 2010

(54) GROUND-FAULT CIRCUIT INTERRUPTER WITH REVERSE WIRING PROTECITON FUNCTION

(75) Inventor: Cheng-Li Li, Shanghai (CN)

Correspondence Address: Chen Yoshimura LLP;Attention Ying Chen, 333 W. El Camino Real, Suite 380, Sunnyvale, CA, 94087, US

(73) Assignee: SHANGHAI ELE MANUFACTURING CORP., Shanghai (CN)

(21) Appl. No.: 12/821,087

(22) Filed: Jun. 22, 2010

(30) Foreign Application Priority Data
Oct. 7, 2008 (CN) 200820153762.5

(51) Int. Cl. H02H 3/00

(52) U.S. Cl. 361/42

(57) ABSTRACT

A ground-fault circuit interrupter (GFCI) power receptacle with reverse wiring protection. The GFCI power receptacle has a circuit board assembled in a housing; a pair of resilient movable conducting arms attached to the circuit board, each having a movable contacts at its free end, a pair of stationary conducting arms each having a stationary contact at one end, and a pair of output face terminals each having a contact. The movable contacts can contact the stationary contacts and the output face terminal contacts to establish electrical connection between the input and output terminals of the power receptacle. The power receptacle has a simple structure where one movable contact can connect or disconnect the load in various working conditions, which can be used in various types of power receptacles.

This application claims foreign priority benefits under 35 U.S.C. §119(a)-(d) from China Patent Application No. 200820153762.5, filed Oct. 7, 2008, which is incorporated by reference in its entirety.

### BACKGROUND OF THE INVENTION

1. Field of the Invention

This invention relates to a power receptacle with ground-fault circuit interrupter (GFCI) functions, and in particular, it relates to a GFCI receptacle with reverse wiring protection function.

2. Description of the Related Art

Power receptacle with ground-fault circuit interrupter (GFCI) functions are widely uses in daily life for electrical appliances. Such receptacles provide protection that ensures the proper function of electrical appliances and safety of users.

In most conventional GFCI receptacles, the connection or disconnection between the input terminals and output terminals of a power receptacle relies on the resilient nature of the resilient moveable conducting arms. However, the uniformity of the resilience of the moving arms is difficult to control during manufacturing, and cannot be completely tested using destructive test. Therefore, if a moving arm is defective in its resilience or losing its resilience after the receptacle has been use for a long period of time, then there may be a misalignment between the electrical contact of the movable conducting arm and the corresponding electrical contact of the stationary conducting arm. This may make the electrical connection of the power receptacle unreliable. In some cases it may cause the loss of the ground fault protection functionality of the power receptacle. More seriously, if the load side experiences an ultra-low ground fault (e.g. over 1,000 A of leakage current), arcs may occur when the electrical contacts of the movable and stationary conducting arms are disconnecting, which may melt the contacts and fuse them together. Thus, even though the disconnect mechanism of the GFCI may still be functional, the contacts are in fact not disconnected. This presents great hidden danger to safety to the users who are not aware of the faulty condition of the power receptacle.

### SUMMARY OF THE INVENTION

The present invention is directed to a GFCI power receptacle with improved safety features.

An object of the present invention is to provide a GFCI with reverse wiring protection function which can correctly connect or disconnect the load in any conditions, and more particularly can automatically and quickly disconnect leakage current when a ground fault condition is present.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, the present invention provides a GFCI power receptacle with reverse wiring protection function, which includes a housing, a circuit board enclosed in the housing, a pair of resilient movable conducting arms attached to the circuit board, a pair of stationary conducting arms, and a circuit interrupter mechanism with circuit interrupter, locking mechanism and electromagnetic element. Also installed in the housing are reset mechanism, test mechanism, and a pair of output receptacle face terminals with electrical contacts. The stationary arms each has an electrical contact at one end, and moving arms each also has an electrical contact at its moving end. The contacts of the moving arms can close on to the contacts of the stationary arms and the face terminals to connect power between the input and output sides of the power receptacle. The power receptacle also provides an improved interrupter mechanism where the interrupter block is located underneath the movable conducting arms, with lifting arms extending from opposite sides of the interrupter block, and a pressing plate located above the movable conducting arms that corresponds with the interrupter block, and a spring disposed above the pressing plate.

In a preferred embodiment, the movable conducting arms are connected to the input terminals of the power receptacle and the stationary conducting arms are connected to the output load terminals of the power receptacle.

In another preferred embodiment, the movable conducting arms are connected to the output terminals of the power receptacle and the stationary conducting arms are connected to the input terminals of the power receptacle.

Selectively, at least one of the movable contacts may connect to or disconnect from at least one of the stationary contacts or face terminal contacts to open or close a neutral power line.

Also selectively, at least one of the movable contacts may connect to or disconnect from at least one of the stationary contacts or face terminal contacts to open or close a hot power line.

Additionally, at least one of the movable contacts may connect to or disconnect from at least one of the stationary contacts or face contacts to open or close the natural line of the face terminals and the down-stream load terminals.

Alternatively, at least one of the movable contacts may connect to or disconnect from at least one of the stationary contacts or face terminal contacts to open or close the hot line of the face terminals and the down-stream load terminals.

In one preferred embodiment, the circuit interrupter block is located underneath the resilient movable conducting arms, with lifting arms extending from opposite sides of the interrupter block, and a pressing plate located above the movable conducting arms that corresponds with the interrupter, and a spring disposed above the pressing plate.

Preferably, the pressing plate has a concave lower surface facing the corresponding lifting arms of the interrupter block. Optionally, the upper surface of the side lifting arms also has a concave shape. Preferably, the concave lower surface of the pressing plate and the concave upper surface of the side lifting arms have a cylindrical shape.

Moreover, the interrupter mechanism includes a supplementary switch disposed below the interrupter block and installed on the circuit board. The supplementary switch has a supplementary moving conducting arm and a supplementary stationary conducting arm with corresponding electrical contacts.

In addition, the pressing plate has two supplementary arms on a side facing the corresponding side lifting arms of the interrupter block, the supplementary arms extending beyond the side lifting arms of the interrupter block to a location adjacent the supplementary moveable conducting arm of the supplementary switch.

The reset mechanism of the GFCI receptacle includes a reset button, a reset shaft attached to the reset button, and a reset spring disposed around the reset shaft. The reset shaft passes through a through hole on the pressing plate, a through hole on the interrupter block and a through hole of the locking member. The interrupter spring is also disposed around the reset shaft below the reset spring.

Preferably, the interrupter spring is separated from the reset spring.

The GFCI receptacle further includes an arc blocking plate disposed between the circuit board and the pair of input conducting arms to block arcs generated when the contacts of the conducting arms are separating from each other. The arc blocking plate may be made of an arc-resistant material, such as PVC, GPO-3 laminated boards, etc.

The present invention has many advantages over conventional technologies. First, the new GFCI receptacle of the present invention has a simple structure and is low cost to produce. It can be effectively used to connect or disconnect load in various working conditions, and can be used in various types of power receptacles.

Second, the new GFFCI receptacle of the present invention is safe and reliable, and easy to use. It can effect the connection or disconnection between the corresponding movable contacts and the stationary contacts simultaneously, to not only prevent fusing of the contacts caused by large local current but also accident caused by mistakes in operation.

Third, the new GFCI receptacle of the present invention has additional pressing plate that corresponds with interrupter spring which effectively increases the engagement between the interrupter block and the movable conducting arms.

Fourth, the new GFCI receptacle of the present invention utilizes a supplemental switch disposed below the interrupter block and mounted on the circuit board, which disconnects the GFCI circuit in the event of a current leakage to prevent damage to the sensing coil by a large current flowing through the device for a long period of time.

It is to be understood that both the foregoing general description and the following detailed description are exemplary and explanatory and are intended to provide further explanation of the invention as claimed.

### BRIEF DESCRIPTION OF THE DRAWINGS

The features and advantages of the preferred embodiments can be further understood from the detailed description below with reference to the following drawings:

FIG. 1 is an exploded perspective view of a GFCI according to an embodiment of the present invention.

FIG. 2 is an exploded view of the interrupter mechanism of the GFCI of FIG. 1 including the new moveable conducting arms.

FIG. 3 is a perspective view of the components in FIG. 2 mounted on the circuit board.

FIG. 4 is a cross-sectional view of the GFCI of FIG. 1 in a reset state.

FIG. 5 is perspective view of a portion of the GFCI of FIG. 1 in the reset state, showing the various contact arms.

FIG. 6 is a cross-sectional view of the GFCI of FIG. 1 in a tripped state.

FIG. 7 is a circuit diagram of the GFCI of FIG. 1.

FIG. 8 is an exploded perspective view of a GFCI according to another embodiment of the present invention.

FIG. 9 is a view showing various components of the GFCI of FIG. 8 mounted on the circuit board.

FIG. 10 is a cross-sectional view of the GFCI of FIG. 8 in a reset state.

FIG. 11 is perspective view of a portion of the GFCI of FIG. 8 in the reset state, showing the various contact arms.

FIG. 12 is a cross-sectional view of the GFCI of FIG. 8 in a tripped state.

FIG. 13 is a circuit diagram of the GFCI of FIG. 8.

### DETAILED DESCRIPTION OF THE PREFERRED EMBODIMENTS

The following numerals are used in the drawing:
1: Top cover
2, 3: Tamper resistant mechanism
4: Reset button
5: Reset shaft
51: Locking slot
6: Test button
7: Grounding frame assembly
71, 72: Grounding plates
8: Interrupter spring
9: Interrupter pressing plate
91, 92: Side lifting Arms of the pressing plate
93, 94: Concave surfaces of the pressing plate
10, 11: Moveable conducting arms
101, 111: moveable contacts
12: Locking member
121: Through hole of the locking member
13: Interrupter block
131, 132: Side arms of the interrupter block
133, 134: Slots on the side arms of the interrupter block
14: Spring for the interrupter plunger
15: Interrupter plunger
16: Interrupter spring frame
161: Interrupter coil spring
17: Supplementary moveable conducting arm
171: Supplementary moveable contacts
18: Supplementary stationary conducting arm
181: Supplementary stationary contacts
19: Middle support frame
20, 21: Output face terminals of the receptacle
201, 211: face terminal contacts
202, 212: Metal plates of the output face terminals
22: Reset spring
23: Test plate
24: Circuit board
25: Reset switch
251: Moveable contact of the reset switch
252: Stationary contact of the reset switch
26: Electromagnetic ring assembly
27, 28: Stationary conducting arms
271, 281: Stationary contacts
29: Base frame
30, 31: Output load terminals of the receptacle
32, 33: Input terminals of the receptacle
34: Screws

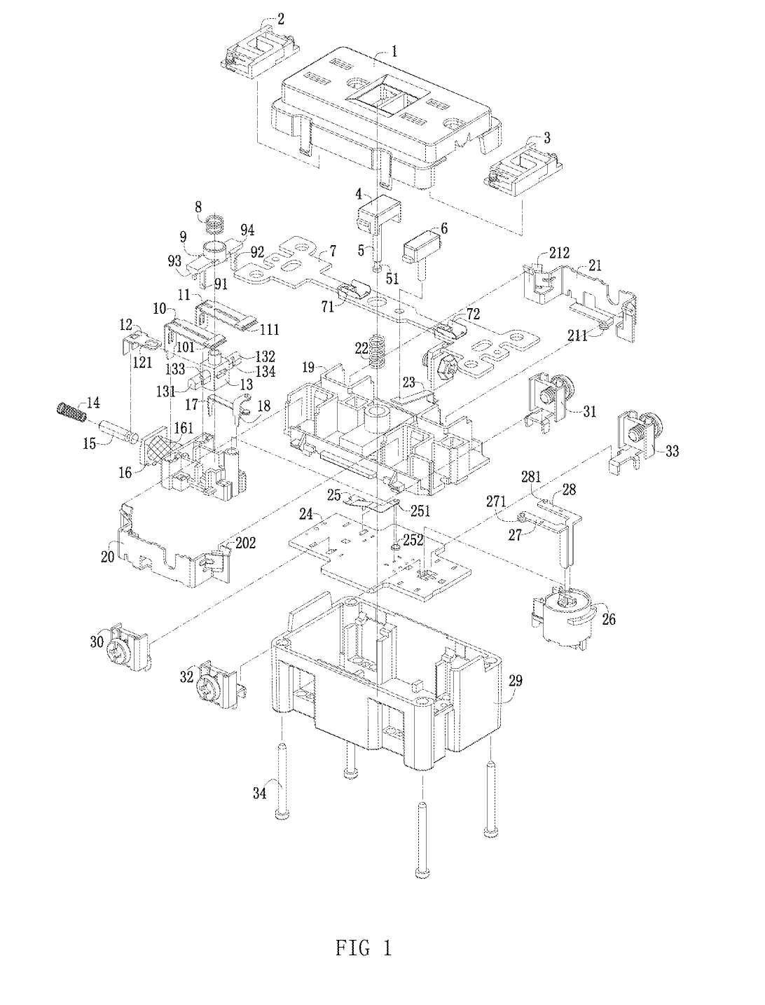

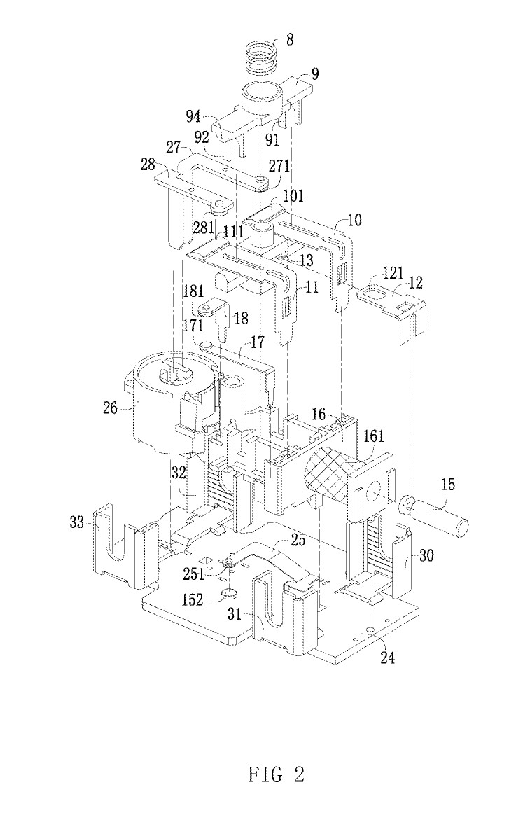

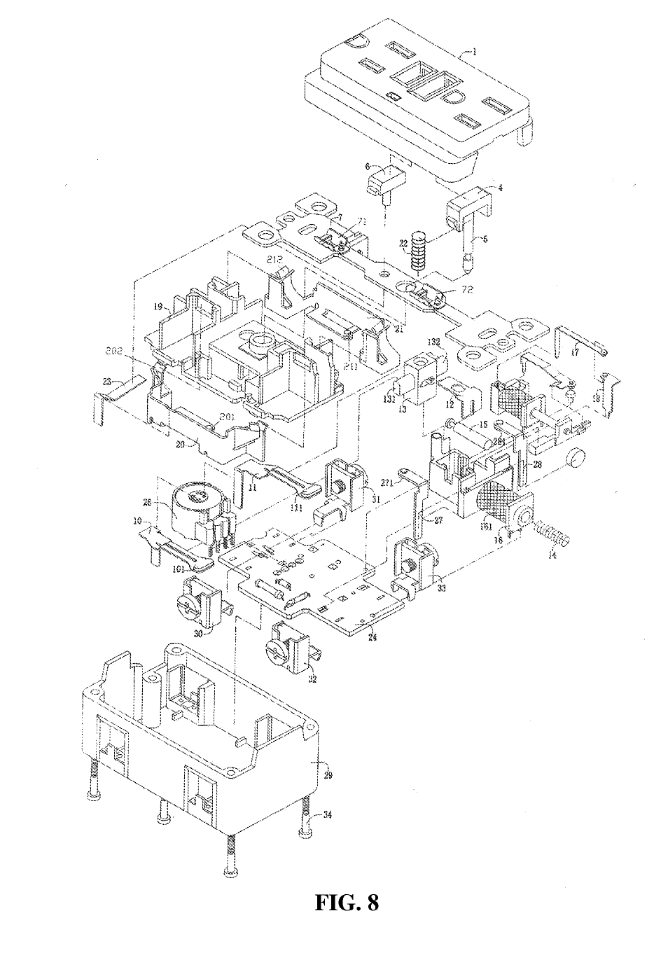

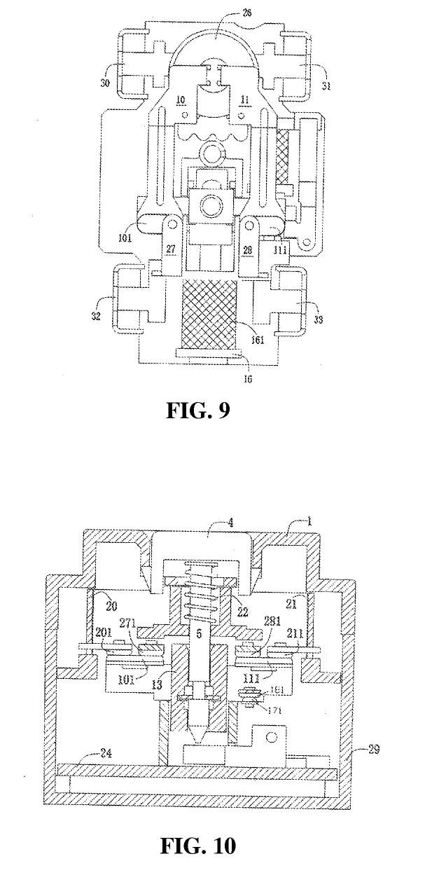

FIGS. 1-7 illustrate the structure of a GFCI receptacle according to one embodiment of the present invention. FIGS. 8-13 illustrate the structure of a GFCI receptacle according to another embodiment of the present invention.

Referring to FIGS. 1-3, the following are provided within a body formed by a top cover 1 and a base frame 29: a middle support frame 19, a grounding frame assembly 7, and a circuit board 24 disposed between the middle support frame 19 and the base frame 29. The circuit board 24 has a pair of resilient moveable conducting arms 10, 11, a pair of stationary conducting arms 27, 28, and an interrupter assembly that includes an interrupter block 13, a locking member 12 and electromagnetic components.

The pair of stationary conducting arms 27, 28 are input conducting arms, with their one ends inserted into the electromagnetic ring assembly 26, while their other ends are provided with input stationary contacts 271, 281. The pair of moveable conducting arms 10, 11 are output conducting arms, and include resilient metal plates where the free ends of the resilient metal plates are provided with moveable contacts 101, 111. On two sides of the middle support frame 19 are output face terminals 20 and 21, which are provided with metal plates 202, 212 aligned with corresponding plug holes on the top cover 1, as well as face terminal contacts 201, 211. Further, grounding plates 71 and 72 are provided on the grounding frame assembly 7, which are coupled to the ground legs and aligned with corresponding plug holes on the top cover 1. The interrupter block 13 is disposed below the pair of moveable conducting arms 10, 11. The interrupter block 13 has two side lifting arms 131, 132 extending outwardly. Above the moveable conducting arms 10, 11 is a pressing plate 9 that cooperates with the interrupter block 13. An interrupter spring 8 is fixedly attached to the pressing plate 9 at its top.

As seen in FIGS. 1-3, in the preferred embodiment, the structure of pressing plate 9 is an elongated plate shape that corresponds to the shape of the interrupter block 13. It should be understood that any suitable structure of the pressing plate 9 may be used so long as it can cooperate with the interrupter block 13 to provide a backing force for the moveable conducting arms 10, 11. The bottom side of the pressing plate 9 may be provided with concave surfaces 93, 94, and the top side of the side arms 131, 132 of the interrupter block 13 may also be provided with concave surfaces in order to enhance the sensitivity of pinching action upon the moveable conducting arms 10, 11. Further, the bottom of the pressing plate 9 has U-shaped arms 91, 92 extending downwardly, which are positioned to be around the side lifting arms 131, 132 of the interrupter block 13 to help the cooperation of the pressing plate 9 and the interrupter block 13. One branch of the U-shaped arms 91, 92 are coupled to the interrupter block 13 by fitting into slots 133, 134 on the side lifting arms 131, 132; the other branch of the U-shaped arms 91, 92 extend beyond the side lifting arms 131, 132 to contact a supplementary moveable conducting arm 17 of a supplementary switch. The supplementary switch, which is mounted on the circuit board 24, has a supplementary stationary conducting arm 18 corresponding to the supplementary moveable conducting arm 17, with a supplementary moveable contact 171 and a supplementary stationary contact 181 on the arms 17 and 18, respectively.

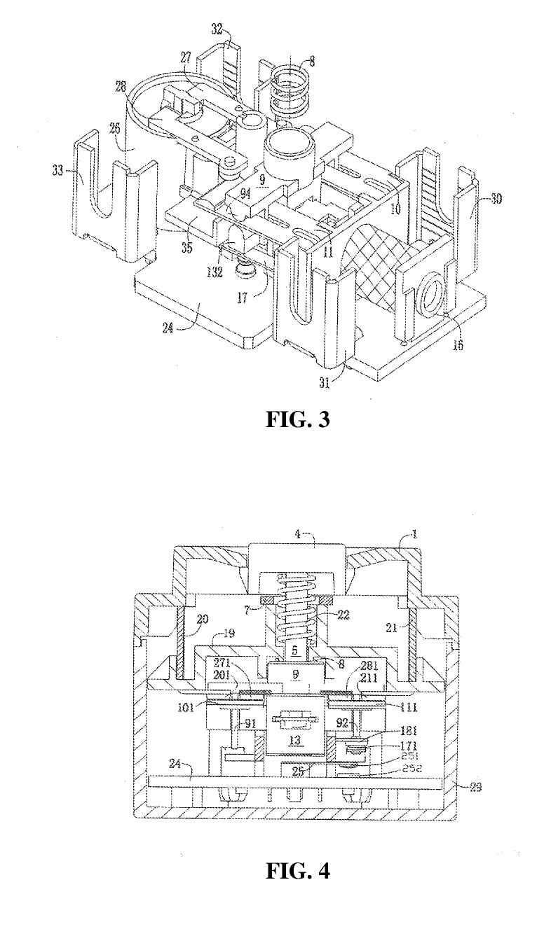

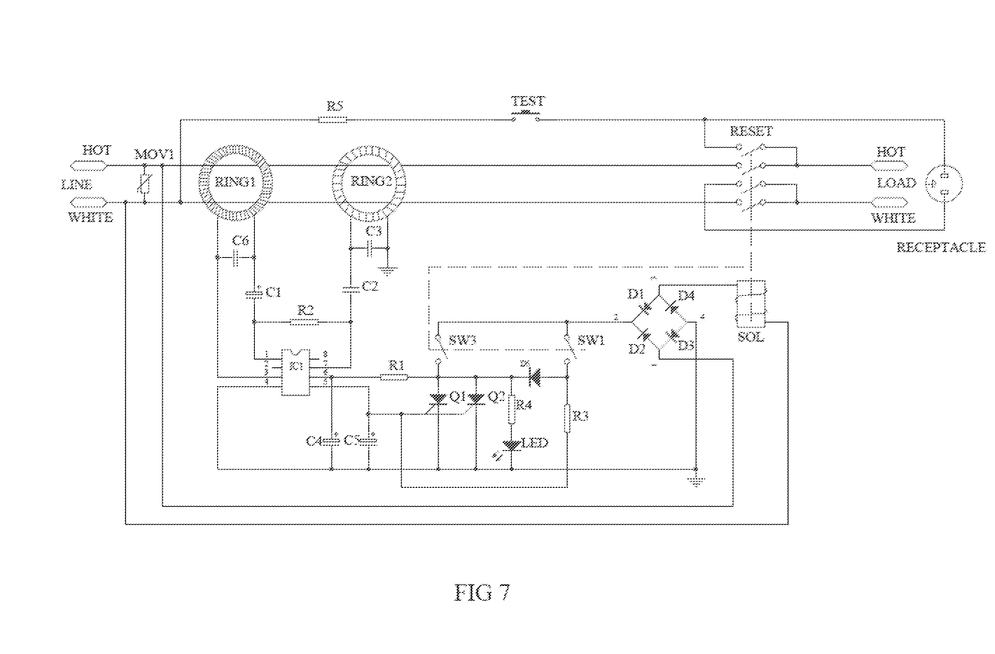

On the pressing plate 9, the interrupter block 13 and the locking member 12, through holes are provided for the reset shaft 5 to pass through. The reset shaft 5 is attached to the reset button 4 and has a reset spring 22 around it. The interrupter spring 8 is disposed above the pressing plate 9, in a sleeve that extends coaxially above the through hole. In is understood that the interrupter spring 8 may be coupled the pressing plate 9 in other suitable ways, such as fixedly soldered. To more reliably couple the pressing plate 9 and the interrupter block 13, another sleeve may be formed on the interrupter block 13 extending coaxially above the through hole and inserted into the through hole of the pressing plate 9. The coupling of the pressing plate 9 and the interrupter block 13 is not limited to the structures described here. Also, the interrupter spring 8 may be disposed around the reset shaft 5, separated from the reset spring 22, as shown in FIGS. 4 and 6.

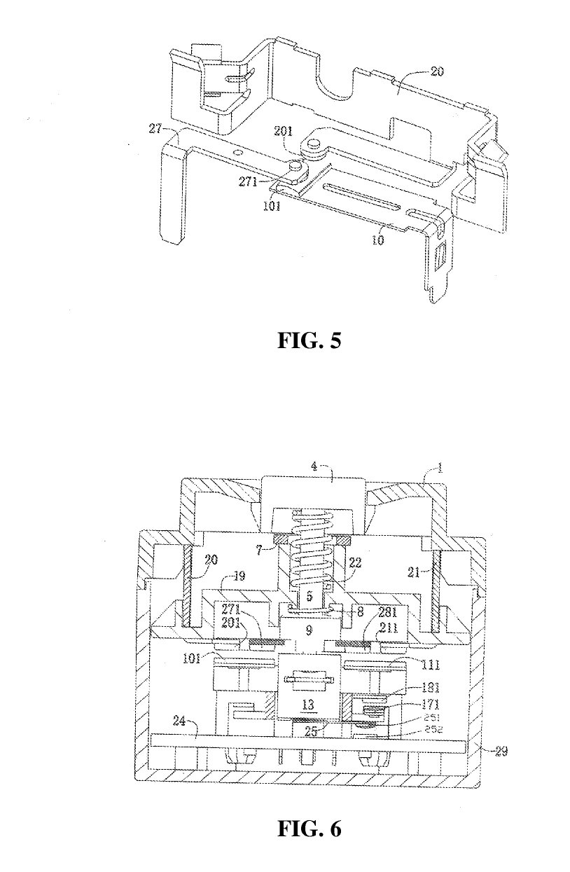

FIG. 4 illustrates the GFCI receptacle in a normally functioning, reset condition. When the reset button 4 is pressed down, the reset shaft moves downward and compresses the reset spring 22. At the same time, the pressing plate 9 and the interrupter block 13 move downward, so that the moveable contact 251 and the stationary contact 252 of the reset switch 25 contact each other. The closing of the reset switch 25 causes a current through the disconnecting coil 161, and the magnetic field of the coil 161 causes the plunger 15 to move. The locking member 12 moves with the plunger 15, and the locking slot 51 of the reset shaft 5 passes through the hole 121 of the locking member 12. Then, the reset switch 25 automatically disconnects due to its resilience, and the coil 161 is de-energized. As a result, the plunger 15 moves back due to the biasing force of the spring 14, bringing the locking member 12 with it, causing the locking slot 51 of the reset shaft 5 to engage the locking member 12 and lock the reset shaft 5. Then, when the pressing force on the reset button is released, the reset spring 22 urges the reset shaft 5 to move upwards. At this time, because the reset shaft 5 is locked with the locking member 12, the reset shaft 5 brings the locking member 12, the interrupter block 13 and the pressing plate 9 upwards. The side lifting arms 131, 132 of the interrupter block 13 pushes the output moveable conducting arms 10, 11 upwards, causing the output moveable contacts 101, 111 to come in contact with input stationary contacts 271, 281 as well as output face terminal contacts 201, 211 of the output face terminals 20, 21. As a result, the input side and the output side of the receptacle are electrically connected, as shown in FIG. 5. It should be noted that the arms 91, 92 of the pressing plate 9 are in contact with the supplementary moveable conducting arm 17 before reset; after reset, because the arms 91, 92 of the pressing plate 9 move upwards, the supplementary moveable contact 171 and the supplementary stationary contact 181 come into contact with each other, which closes the supplementary switch 17/18.

When current leakage occurs within the receptacle, as shown in FIG. 6, the electromagnetic ring assembly detects the leakage and generates an electromagnetic field in the disconnecting coil 161. The disconnecting plunger 15 pushes the locking member 12 to move, so that the locking slot 51 of the reset shaft 5 escapes from the through hole 121 of the locking member 12 and moves upwards by the force of the reset spring 22. As a result, the pressing plate 9 and the interrupter block 13 falls downwards. The interrupter spring 8, which has been previously compressed by the pressing plate 9, forces the pressing plate 9 to move downwardly quickly. The pressing plate 9 pushes the output moveable conducting arms 10, 11 downwardly, causing the output moveable contacts 101, 111 to be separated from the input stationary contacts 271, 281 as well as the output face terminal contacts 201, 211 of the output face terminals 20, 21. As a result, the electrical connection between input side and the output side of the receptacle is quickly disconnected. Also, because the pressing plate 9 moves downwards quickly, the arms 91, 92 of the pressing plate 9 re-establishes contact with the supplementary moveable conducting arm 17 and presses it down, the supplementary moveable conducting terminal 171 is separated from the supplementary stationary conducting terminal 181.

Comparing to the separate contacts in existing technologies, the increase surface areas of movable contacts 101, 111 will reduce the possible electrical arc and prevent the damage to the contacts by the possible arc. In addition, by the action of the interrupter mechanism, the movable contacts are simultaneously disconnected from the stationary contacts and the face terminal contacts, effectively prevent large current between the contacts.

The new GFCI also provides a test plate 23 between the output terminal 21 and the test button 6 to form a testing mechanism, to test whether the circuit interrupter is functioning properly through a simulated leakage current circuit. Further, tamper resistance devices 2 and 3 may be provided between the top cover 1 and the grounding frame assembly 7. Output load terminals 30, 31 and input terminals 32, 33 of the receptacle are located on both sides of the base frame 29. Finally, screws 34 fasten the top cover 1, the middle support frame 19 and the base frame 29 together to form the assembled receptacle.

According to the circuit diagram shown in FIG. 7, it can be seen and understood, when reset the connection between the input contacts and the output contacts will effect the power connection between the LINE side and LOAD side of the receptacle. At least one of the movable contacts may connect to or disconnect from at least one of the stationary contacts or face terminal contacts to open or close a neutral (WHITE) power line, and at least one of the movable contacts may connect to or disconnect from at least one of the stationary contacts or face terminal contacts to open or close a HOT power line.

In addition, in the GFCI of the present invention, at least one of the movable contacts may connect to or disconnect from at least one of the stationary contacts or face terminal contacts to open or close the natural (WHITE) line of the face terminals and the down-stream load terminals, and at least one of the movable contacts may connect to or disconnect from at least one of the stationary contacts or face terminal contacts to open or close the hot line of the face terminals and the down-stream load terminals.

In the other embodiment shown in FIGS. 8-13, the conducting arms 10, 11 attached to the electromagnetic assembly 26 are resilient movable arms, which are connected to the input side of the power receptacle, whereas the conducting arms 27, 28 are stationary arms connected to the output side of the power receptacle. In this embodiment, the reset and tripping operations are similar to those of the embodiment described above in connection with FIGS. 1-7.

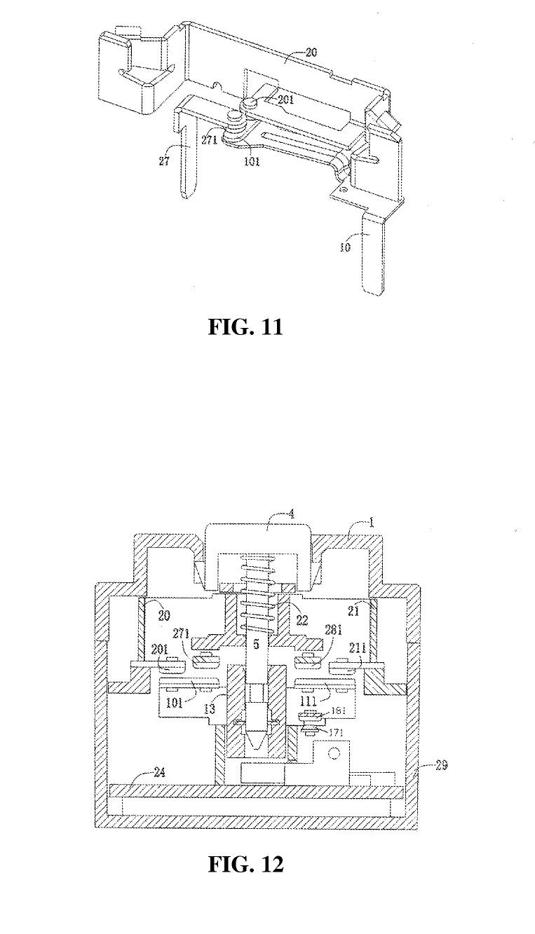

Referring to FIGS. 10-12 now, wherein FIG. 10 shows the GFCI in reset state. Because of the operation of the interrupter block 13, movable contacts 101, 111 are connected with the stationary contacts 271, 281 and output face terminal contacts 201, 211 respectively, effecting the power connection between the input and output sides of the power receptacle, as shown in FIG. 11. As the same time, the supplementary stationary and movable contacts 181, 171 of the supplementary conducting arms 17, 18 of the supplementary switch are also connected. In the disconnected status as shown in FIG. 12, the output movable conducting arms 10, 11 are promptly pressed down by the pressing plate 9, causing disconnection between movable contacts 101, 111 and the stationary contacts 271, 281 and output face terminal contacts 201, 211 respectively. At the same time, the downward movement of the pressing plate 9 also causes the disconnection of the supplementary stationary and movable contacts 181, 171.

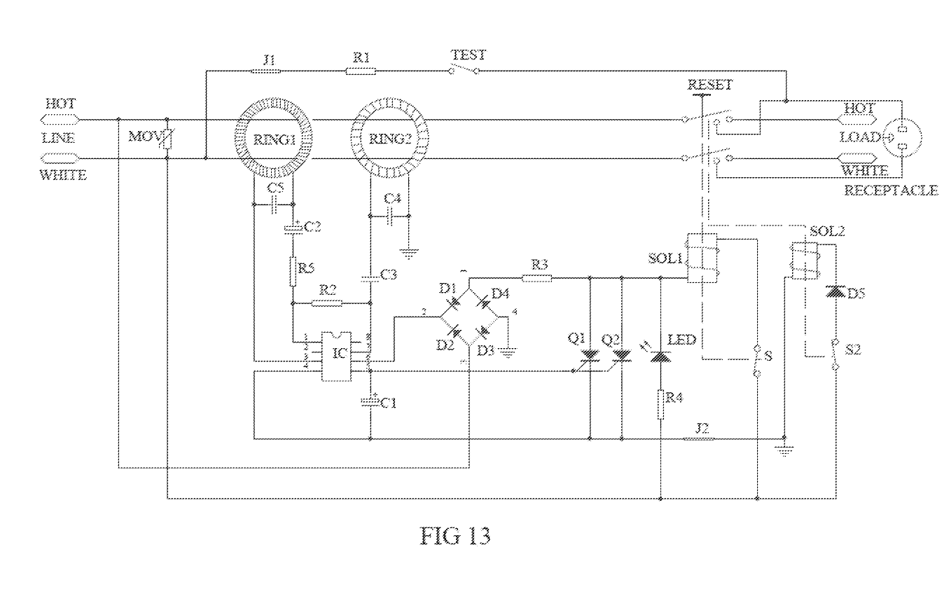

Similarly, from the circuit diagram shown in FIG. 13, in the present invention GFCI, at least one movable conducting arm can effect the connection or disconnection of input neutral (WHITE) line or input hot line, and of the neutral (WHITE) line or hot line of the face terminal or output terminal. Therefore, the movable conducting arm design of the present invention GFCI can effectively avoid the drawbacks from internal connection defect or failure and also quickly disconnect power to the face terminals and down-stream load terminals of the receptacle upon the occurrence of a ground fault or other incident, to ensure the safe use of electrical power.

It will be apparent to those skilled in the art that various modification and variations can be made in the power receptacle of the present invention without departing from the spirit or scope of the invention. Thus, it is intended that the present invention cover modifications and variations that come within the scope of the appended claims and their equivalents.

What is claimed is:

1. A ground-fault circuit interrupter (GFCI) power receptacle with reverse wiring protection, comprising:
a housing;
a circuit board assembled in the housing;
a pair of resilient movable conducting arms attached to the circuit board, each having a movable contacts at its free end;
a pair of stationary conducting arms each having a stationary contact at one end;
a pair of input terminals and a pair of output load terminals attached to said housing;
the movable conducting arms electrically connected respectively to one of the pairs of input terminals and the pair of output terminals, and the stationary conducting arms electrically connected respectively to the other one of the pairs of input terminals and the pairs of output terminals;
an interrupter assembly including a locking member, an interrupter block and electromagnetic components;
a reset mechanism and a test mechanism assembled in the housing; and
a pair of output face terminals each having a contact;
wherein the movable contacts can contact the stationary contacts and the output face terminal contacts to establish electrical connection between the input and output terminals of the power receptacle.

2. The GFCI power receptacle of claim 1, wherein the pair of movable conducting arms are electrically connected respectively to the pair of input terminals, and the pair of stationary conducting arms are electrically connected respectively to the pair of output terminals.

3. The GFCI power receptacle of claim 1, wherein the pair of movable conducting arms are electrically connected respectively to the pair of output terminals, and the pair of stationary conducting arms are electrically connected respectively to the pair of input terminals.

4. The GFCI power receptacle of claim 1, wherein the connection or disconnection between at least one movable contact of the pair of movable conducting arms and at least one stationary contact of the pair of stationary conducting arms or at least one face terminal contact of the pair of output face terminals can connect or disconnect at one neutral line connection between the input and output terminals of the power receptacle.

5. The GFCI power receptacle of claim 1, wherein the connection or disconnection between at least one movable contact of the pair of movable conducting arms and at least one stationary contact of the pair of stationary conducting arms or at least one face terminal contact of the pair of output face terminals can connect or disconnect at one hot line connection between the input and output terminals of the power receptacle.

6. The GFCI power receptacle of claim 1, wherein the connection or disconnection between at least one movable contact of the pair of movable conducting arms and at least one stationary contact of the pair of stationary conducting arms or at least one face terminal contact of the pair of output face terminals can connect or disconnect the neutral line connection between the output load terminals and the output face terminals of the power receptacle.

7. The GFCI power receptacle of claim 1, wherein the connection or disconnection between at least one movable contact of the pair of movable conducting arms and at least one stationary contact of the pair of stationary conducting arms or at least one face terminal contact of the pair of output face terminals can connect or disconnect the hot line connection between the output load terminals and the output face terminals of the power receptacle.

8. The GFCI power receptacle of claim 1, further comprising:
two side arms extending from the opposite side of the interrupter block and disposed below the pair of moveable conducting arms;
a pressing plate disposed above the interrupter block; and
an interrupter spring disposed above the pressing plate.

9. The GFCI power receptacle of claim 8, wherein the pressing plate has concave surfaces facing the corresponding side arms of the interrupter block.

10. The GFCI power receptacle of claim 8, further comprising a supplementary switch disposed under the interrupter block, the supplementary switch including a moveable conducting arm having a movable contact and a stationary conducting arm having a stationary contact.

11. The GFCI power receptacle of claim 10, wherein the pressing plate has two arms on a side facing the corresponding side arms of the interrupter block, the arms extending beyond the side arms of the interrupter block to a location adjacent the moveable conducting arm of the supplementary switch.

12. The GFCI receptacle of claim 8, wherein the reset mechanism includes:
a reset button;
a reset shaft attached to the reset button; and
a reset spring disposed around the reset shaft,
wherein the reset shaft passes through a through hole on the pressing plate, a through hole on the disconnect block and a through hole of the locking member,
wherein the interrupter spring is disposed around the reset shaft and below the reset spring.

13. The GFCI receptacle of claim 12, wherein the interrupter spring is separated from the reset spring.

14. The GFCI receptacle of claim 1, further comprising an arc blocking plate disposed between the circuit board and the pair of stationary conducting arms to block arcs generated when the contact between the movable contacts and the stationary contacts and the output ace terminal contacts are broken.
